(19) United States
(12) Patent Application Publication
(10) Pub. No.: US 2011/0154668 A1
(43) Pub. Date: Jun. 30, 2011

(54) DOUBLE STRENGTH LOPPERS

(76) Inventors: Hongbin Liu, Hangzhou (CN); Jun Zhang, Hangzhou (CN); Maocai Huang, Hangzhou (CN)

(21) Appl. No.: 12/965,498

(22) Filed: Dec. 10, 2010

(30) Foreign Application Priority Data
Dec. 25, 2009 (CN) 200920318571.4

(51) Int. Cl. A01G 3/08

(52) U.S. Cl. 30/252

(57) ABSTRACT

Double strength loppers employ double leverage effects and have two crossed pivoting blades, a main blade and an auxiliary blade, an upper handle and a lower handle correspondingly matching with the two blades, an upper gear at the end of the upper handle and a lower gear at the end of the lower handle. The lower gear matches with the blade driving gear and the blade driving gear matches with the auxiliary blade. When swinging the upper handle and/or the lower handle, a first leverage effect is created from a first fulcrum that is the contact point between the upper gear and the lower gear, while a second leverage effect is created from a second fulcrum that is the contact point between the lower gear and the blade driving gear. Such double levers and double strength effects significantly reduce the force applied upon the handles, therefore reducing the required labor.

This application claims the benefit of Chinese Application No. 200920318571.4, filed Dec. 25, 2009, which is hereby incorporated by reference in its entirety.

### BACKGROUND

Conventional loppers have two blades connected by a pin axis and handles fastened to the blades. With a fixed handle length and settled pin axis position, force applied to the blades is invariable. When cutting and trimming high branches of ornamental trees, users have to raise loppers. This position is more difficult than cutting horizontally or downwards, therefore requiring extensive labor. Cutting bigger branches is even more difficult. Sometimes they even fail to cut big branches.

Needs exist for improved loppers requiring less force for operation.

### SUMMARY

It is to be understood that both the following summary and the detailed description are exemplary and explanatory and are intended to provide further explanation of the invention as claimed. Neither the summary nor the description that follows in intended to define or limit the scope of the invention to the particular features mentioned in the summary or in the description. Rather, the scope of the invention is defined by the appended claims.

In certain embodiments, the disclosed embodiments may include one or more of the features described herein.

A new double strength lopper has a main blade and an auxiliary blade connected by a pivot, an upper handle and a lower handle correspondingly matching with the main blade and the auxiliary blade, an upper gear and a lower gear positioned correspondingly at the end of the upper handle and the lower handle, and a blade driving gear matching with the auxiliary blade. The lower gear matches with the blade driving gear.

In one embodiment, an upper connecting bar and a lower connecting bar are correspondingly positioned on top of the upper handle and lower handle and the upper gear and the lower gear are correspondingly positioned on the outer side of the upper connecting bar and the lower connecting bar. The upper connecting bar and the lower connecting bar are connected by a first link and the blade driving gear and the lower connecting bar are connected by a second link. The first link is connected via pivots to the upper connecting bar and the lower connecting bar and the second link is connected via pivots to the blade driving gear and the lower connecting bar. The main blade and the auxiliary blade are correspondingly connected to the upper connecting bar and the lower connecting bar.

In some embodiments, a kidney-shaped hole is positioned on the blade driving gear and matches the pivot. A first kidney-shaped adjustable connecting hole and second kidney-shaped adjustable connecting hole are correspondingly positioned at the ends of the main blade and the auxiliary blade. The main blade and the auxiliary blade are correspondingly connected through the first and second kidney-shaped adjustable connecting holes and are connected to the upper connecting bar and the lower connecting bar.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a diagram showing the exploded structure of a double strength lopper.

FIG. 2 is a diagram showing the two blades of a double strength lopper in an open position.

FIG. 3 is a diagram showing the two blades of a double strength lopper in a closed position.

### DETAILED DESCRIPTION

Double strength loppers will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

New double strength loppers contain three sets of gear driving pieces and employ double leverage effects. With double strength from two levers, these loppers reduce the power originally required to cut high branches, require less labor, and resolve the problems of current technology.

In some embodiments the double strength loppers include a main blade and auxiliary blade connected to a pivot, and upper and lower handles correspondingly matching with the main and auxiliary blades. The features include an upper gear and a lower gear, positioned correspondingly at the end of the upper handle and the lower handle, the lower gear also matching with a blade driving gear, and the blade driving gear matching with the auxiliary blade.

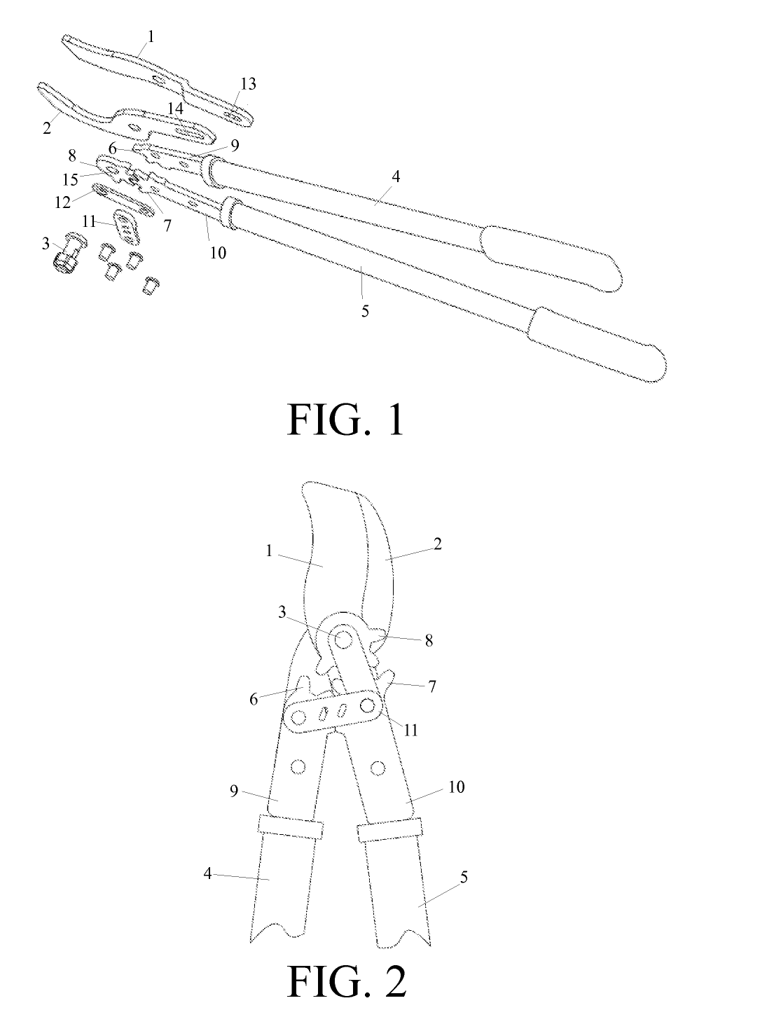

The upper and lower handle and the upper and lower gear refer to relative positions. The main and auxiliary blades are also relative. They are used for the purpose of convenience to differentiate the two blades, the upper and lower handles, and the upper and lower gears (see FIGS. 1 and 2 for details). This also applies to the following references to upper and lower, main and auxiliary.

In use, when swinging the upper handle and/or lower handle, the upper gear and lower gear correspondingly rotate. A first leverage effect is created from the first fulcrum that is the contact point between the upper gear and lower gear, while a second leverage effect is created from the second fulcrum that is the contact point between the lower gear and the blade driving gear. Such double levers and double strength effect can significantly reduce the force applied upon the upper and lower handles, therefore reducing the required labor. With this design, it is relatively easy to cut bigger branches.

To perfect and supplement the above design, in some embodiments these loppers include further innovations. The end of the upper handle and lower handle contain an upper connecting bar and a lower connecting bar. The upper gear and lower gear are positioned correspondingly on the outer side of the upper connecting bar and lower connecting bar. Due to wear and tear or rupture, the upper and lower connecting bar can be replaced without replacing the handles, which reduces maintenance cost.

The upper connecting bar and the lower connecting bar are connected by Link A. The blade driving gear and the lower connecting bar are connected by Link B. Link A moves the upper connecting bar and lower connecting bar to rotate around the contact point between the upper gear and lower gear. Link B enables the lower gear and the blade driving gear to always engage with each other during the rotation.

The Link A is connected via pivots to the upper connecting bar and lower connecting bar (10). The Link B is connected via pivots to the blade driving gear and the lower connecting bar. Connection via pivots helps rotation.

The auxiliary blade and main blade are correspondingly connected with the upper connecting bar and lower connecting bar, which enables the blades to open and close smoothly.

A kidney-shaped hole is positioned on the blade driving gear. The kidney-shaped hole matches the pivot. The design of the kidney-shaped hole can finely adjust the position of the blade driving gear, which can prevent the wear and tear resulted from the engaging rotation of the blade driving gear and the lower gear and also prevent hindered opening and closing of the blades.

Kidney-shaped adjustable connecting hole A and kidney-shaped adjustable connecting hole B are correspondingly positioned at the end of the main blade and the auxiliary blade. The main blade and the auxiliary blade correspondingly perforate kidney-shaped adjustable connecting hole A and kidney-shaped adjustable connecting hole B and connect to the upper connecting bar and the lower connecting bar. Kidney-shaped adjustable connecting hole A and kidney-shaped adjustable connecting hole B can finely adjust the corresponding connecting positions of the main blade and auxiliary blade with the lower connecting bar and upper connecting bar.

The benefits include: 1. when swinging the upper handle and/or lower handle, a first leverage effect is created from the first fulcrum that is the contact point between the upper gear and lower gear, while a second leverage effect is created from the second fulcrum that is the contact point between the lower gear and the blade driving gear. Such double levers and double strength effect can significantly reduce the force applied upon the upper and lower handles, therefore reducing the required labor. 2. The upper gear and lower gear are correspondingly positioned on the upper and lower connecting bar, which forms a detachable structure with the upper and lower handles, for easy maintenance and replacement. 3, A fine-adjustment positioning hole is positioned on the blade driving gear, the main blade, and auxiliary blade, which can finely adjustment relevant positions. This design makes loppers function more reliably.

The following further explains the technology of this utility model by illustrating its operation in connection with the drawings.

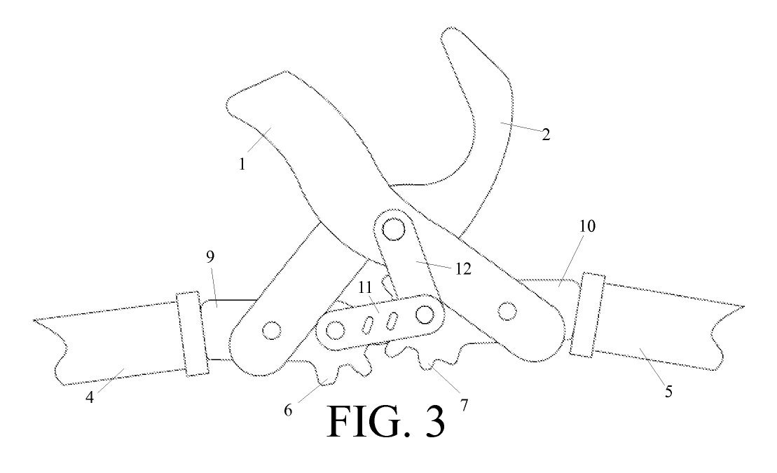

Operation: As illustrated by FIGS. 1-3, in some embodiments double strength loppers include a main blade (1) and auxiliary blade (2) connected by a pivot (3), an upper handle (4) and a lower handle (5) correspondingly matching with the main blade (1) and auxiliary blade (2), an upper gear (6) and lower gear (7), positioned correspondingly at the end of the upper handle (4) and lower handle (5), the lower gear (7) also matching with a blade driving gear (8), and the blade driving gear (8) matching with the auxiliary blade (2). A kidney-shaped hole is positioned on the blade driving gear (8). The kidney-shaped hole matches the pivot (3).

The upper connecting bar (9) and lower connecting bar (10) are correspondingly positioned on the top of the upper handle (4) and lower handle (5). The upper gear (6) and lower gear (7) are correspondingly positioned on the outer side of the upper connecting bar (9) and lower connecting bar (10).

Kidney-shaped adjustable connecting hole A (13) and kidney-shaped adjustable connecting hole B (14) are correspondingly positioned at the end of the main blade (1) and the auxiliary blade (2). The main blade (1) and the auxiliary blade (2) correspondingly perforate Kidney-shaped adjustable connecting hole A (13) and kidney-shaped adjustable connecting hole B (14) and connect to the upper connecting bar (9) and the lower connecting bar (10).

The upper connecting bar (9) and the lower connecting bar (10) are connected by Link A (11); The blade driving gear (8) and the lower connecting bar (10) are connected by Link B (12). The Link A (11) is connected via pivots to the upper connecting bar (9) and the lower connecting bar (10); The Link B (12) is connected via pivots to the blade driving gear (8) and the lower connecting bar (10).

In use, when swinging the upper handle and/or lower handle, the upper gear and lower gear correspondingly rotate. A first leverage effect is created from the first fulcrum that is the contact point between the upper gear and lower gear, while a second leverage effect is created from the second fulcrum that is the contact point between the lower gear and the blade driving gear. Such double levers and double strength effect can significantly reduce the force applied upon the upper and lower handles, therefore reducing the required labor. With this design, it is relatively easy to cut bigger branches.

The invention is not limited to the particular embodiments illustrated in the drawings and described above in detail. Those skilled in the art will recognize that other arrangements could be devised. The invention encompasses every possible combination of the various features of each embodiment disclosed. While the invention has been described with reference to specific illustrative embodiments, modifications and variations of the invention may be constructed without departing from the scope of the invention.

1. A double strength lopper comprises:
a main blade and an auxiliary blade connected by a pivot;
an upper handle and a lower handle correspondingly matching with the main blade and the auxiliary blade;
an upper gear and a lower gear, positioned correspondingly at the end of the upper handle and the lower handle; and
a blade driving gear matching with the auxiliary blade;
wherein the lower gear matches with the blade driving gear.

2. A double strength lopper according to claim 1, further comprising an upper connecting bar and a lower connecting bar correspondingly positioned on top of the upper handle and lower handle, wherein the upper gear and the lower gear are correspondingly positioned on the outer side of the upper connecting bar and the lower connecting bar.

3. A double strength lopper according to claim 2, wherein the upper connecting bar and the lower connecting bar are connected by a first link and the blade driving gear and the lower connecting bar are connected by a second link.

4. A double strength lopper according to claim 3, wherein the first link is connected via pivots to the upper connecting bar and the lower connecting bar and the second link is connected via pivots to the blade driving gear and the lower connecting bar.

5. A double strength lopper according to claim 2, wherein the main blade and the auxiliary blade are correspondingly connected to the upper connecting bar and the lower connecting bar.

6. A double strength lopper according to claim 1, further comprising a kidney-shaped hole positioned on the blade driving gear and matching the pivot.

7. A double strength lopper according to claim 5, further comprising a kidney-shaped hole positioned on the blade driving gear and matching the pivot.

8. A double strength lopper according to claim 6, further comprising a first kidney-shaped adjustable connecting hole and second kidney-shaped adjustable connecting hole correspondingly positioned at the end of the main blade and the auxiliary blade, wherein the main blade and the auxiliary blade are correspondingly connected through the first and second kidney-shaped adjustable connecting holes and are connected to the upper connecting bar and the lower connecting bar.

9. A double strength lopper according to claim 7, further comprising a first kidney-shaped adjustable connecting hole and second kidney-shaped adjustable connecting hole correspondingly positioned at the end of the main blade and the auxiliary blade, wherein the main blade and the auxiliary blade are correspondingly connected through perforate the first and second kidney-shaped adjustable connecting holes and are connected to the upper connecting bar and the lower connecting bar.
